(19) United States
(12) Patent Application Publication
(10) Pub. No.: US 2004/0036577 A1
(43) Pub. Date: Feb. 26, 2004

(54) Anti-theft device and method for use in products with electric or electronic components therein

(76) Inventor: Robert Simoneau, Chambly (CA)

Correspondence Address: BIRCH STEWART KOLASCH & BIRCH, PO BOX 747, FALLS CHURCH, VA, 22040-0747, US

(21) Appl. No.: 10/333,339

(22) PCT Filed: Jul. 11, 2001
(86) PCT No.: PCT/CA01/01016

(30) Foreign Application Priority Data
Jul. 21, 2000 (CA) 2314199

(51) Int. Cl. G08B 13/14

(52) U.S. Cl. 340/10.51; 340/572.3

(57) ABSTRACT

The anti-theft device (12) and method are for use in products (10) provided with electric and electronic components therein. The device (12) in embedded, or other wise unreachable, in the product (10) to be protected. The device (12) is able to wirelessly interact with detectors (14) located at checkpoints of a secured area in order to generate and alarm event whenever someone is attempting to take the product (10) out without the security feature being turned off. Moreover, the device (12) denies benefit of use of some or even all the features of the products (10) if proper authorization is not released by or from someone holding rights to the product (10). The device (12) also allows a product (10) to be disabled from a distance, for instance if a client fails to pay fees for leasing the product (10).

The present invention relates to an anti-theft device and a method for use in products which are provided with electric or electronic components therein. More particularly, the invention relates to a device combining the features of a security tag or label for use in a retail store or in any relevant location, and a contactless (de)activator capable of denying benefits of use unless proper authorization is obtained, for example following proper payment of the product.

It is well known that shoplifting is a problem everywhere in the world. Each year, retail stores lose billion of dollars due to shop lifting, vendor frauds, employee theft, etc. Electronically-controlled products are certainly a prime target for shoplifters because of their usual high value and also because they are in high demand. Consequently, they are easy to resell. Nevertheless, about any product is susceptible to be stolen from a retail store. All these criminal activities result in lost profits for retail stores and ultimately, a higher price for legally purchasing products.

Shoplifting is a problem addressed by many security system manufacturers, all of which provide various systems and methods to detect the theft of products found in retail stores or, as aforesaid, any other protected or secured areas. While these prior art attempts to provide anti-theft systems and methods for use on products sold in retail stores have resulted in a number of different constructions, none have been found to be completely satisfactory for various reasons. For instance, some prior art systems include a label or security tag which is affixed to, associated with, or otherwise secured to a product to be protected or its packaging. Security tags may take on many different sizes, shapes and forms, depending on the particular type of security system in use, the type and size or the article, etc.

In general, an electronic article surveillance system is employed for detecting the presence of an active security tag or label as it passes through a detector at a security checkpoint of the secured area, generally adjacent to the doorways of the retail store. Unless the security tags or labels are deactivated, disabled or physically removed, such as removed by the cashier at the point-of-sale (POS), passing through a detector generates an alarm signal. Although this is a deterrent for most thefts, it does not prevent or discourage thefts by persons equipped with portable disablers or someone grabbing and running through the door with stolen goods. Also, it generally does not prevent or discourage theft by employees of the retail store, who may hide the items and carry them out through a back door or in another manner. Furthermore, the stolen device would be operational regardless of whether or not it has an security tag or label.

In view of the foregoing, there is thus a need for an anti-theft device which is capable of interacting with a detector at a security checkpoint to trigger an alarm when someone is trying to steal a product from a retail store, and also capable of denying benefit of use of at least some, but preferably all functions of the product, in particular a product having electric or electronic components therein. Cutting a power supply or disabling a processor in the product will result in the product being inoperative or partially inoperative. Conversely, a legally-purchased product will gain full operation upon activation by a cashier at the POS using a wireless device, or through a wireless communication network receiving an authorization from the retail store to activate the product from a distance.

In particular, the present invention is concerned with an anti-theft device for use in a product having an electric or electronic component therein. The device first comprises first means for receiving a first activation signal from an electronic article surveillance system and transmitting a response signal upon receiving the first activation signal. The device is characterized in that it also comprises second means for selectively enabling and disabling normal operation of the product; and third means for receiving a second activation signal, the third means being coupled to the second means so that normal operation of the product is enabled upon receiving the second activation signal.

It also relates to a method of protecting a product having an electric or electronic component therein. The method first comprises receiving a first activation signal from an electronic article surveillance system and transmitting a response signal upon receiving the first activation signal. The method is characterized in that it also comprises (a) providing a product in an at least partially disabled state; (b) receiving at the product a second activation signal from a wireless activation device; (c) validating the second activation signal; and (d) enabling normal operation of the product upon determining that the second activation signal is valid.

These and other aspects and advantages of the present invention are described in or apparent from the following detailed description of a preferred embodiment made in conjunction with the accompanying figures, in which:

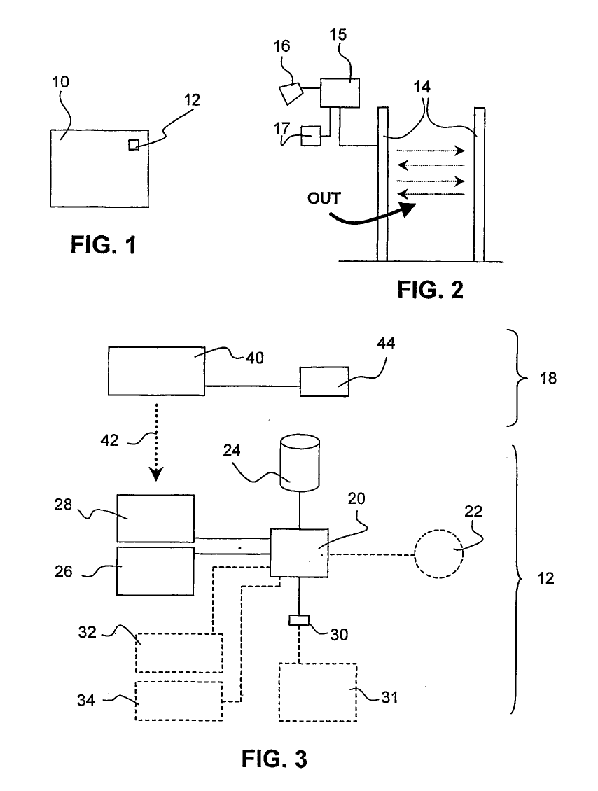

FIG. 1 is a schematic view of a product in which an anti-heft device is embedded.

FIG. 2 is a schematic view of a detector and corresponding control system to detect if someone is trying come out of a secured area with an undisabled anti-theft device.

FIG. 3 is a bloc diagram showing the various components of the anti-theft device in accordance with a possible embodiment of the present invention.

The present invention is used in products that are provided with electric or electronic components therein, namely any product that has one or some functions using electrical power and for which denying benefit of use to these functions results in the product have less, even no value. Thus, this includes any electric or electronic products, appliances, vehicles, tools, etc., with or without microprocessors. However, the present invention is particularly suitable with small or relatively small electronic products because of their high value and the risks associated with having them stolen from retail stores. Nevertheless, the present invention can be used with almost any product in which a security device can affect normal operation.

It should be noted that the expressions “retail store” or “retail stores” in the description and claims are intended to mean any store, merchant, renter or even any location or facility where security is an issue. Therefore, it should not be interpreted in a limiting manner.

Turning first to FIG. 1, there is schematically shown a product (10) which includes an anti-theft device (12) in accordance with the present invention. This device (12) is to be embedded, hidden, or otherwise unreachable, so that it would be difficult, ideally impossible, to remove it or gain access to its internal components. The device (12) may be either included the product (10) when it was manufactured. It can also be later installed by the manufacturer, retail stores or third parties before being offered for sale. Further, it is possible that products be retrofitted for the after-sale market.

Referring now to FIG. 2, there is shown an example of a two-part detector (14) creating a checkpoint through with any client of the store must go to leave the secured area. The detector (14) comprises a transmitter designed to generate an interrogation electromagnetic field used to activate the security tag, namely to generate a response signal from a security tag which was not disabled. Any relevant response is then received by the receiver portion of the detector (14). Alternatively, the security tag or label may be used to create a disturbance in the electromagnetic field that is sensed by the receiver of the detector (14). If a signal from the security tag or a disturbance is sensed by the detector (14), a controller (15) generates an alarm signal.

Generally, an alarm signal is an audible signal generated by a siren (16) or any similar device to create an audible signal. A visible signal could also be generated using a light (17), for example to indicate the exact location of the detector through which a possible theft was detected. It is also possible to generate a “silent” alarm, especially when hidden detectors are used. In the later case, the alarm signal will be known by security agents. It is further possible to automatically lock the exit doors of the retail store whenever an alarm signal is sent.

FIG. 3 illustrates an example of an anti-theft device (12) and a wireless communication system (18) to communicate therewith. The device (12) comprises a central processor (20) which is powered either passively through inductive couplings or, optionally, using a battery (22). The processor is coupled to a memory unit (24) where information is stored. The memory can also be embedded within the processor (20).

The processor (20) is connected to a transponder module (26). The transponder (26) is designed to receive the signal emitted by the detector (14) and to transmit a response signal if the appropriate activation signal is received, unless that function is disabled. This response is preferably at a frequency that cause a detectable disturbance in the electromagnetic field between the two parts of the detector (14), such as the one illustrating in FIG. 2. Example of these frequencies are currently 58 kHz and 8.2 MHz. It is also possible to have a direct communication between the transponder (26) and the receiver of the detector (14) so as to transmit information such as the serial number of the product or any other relevant information. In that case, the controller (16) or an apparatus connected to it may be required to consult a database of recently purchased products so as to verify if someone carrying the product out of the store is its legitimate owner or not. Recording the serial number of products at security checkpoints may be useful for keeping an updated view of the inventory in real time.

As can be appreciated, since the anti-theft device (12) is usually embedded or otherwise unreachable within the product (10) to be protected, it is not possible for a shoplifter to physically remove it using a special tool or any other technique, at least while they are in a retail store.

The device (12) also comprises a receiver (28) which is also connected to the processor (20). The receiver (28) is designed to receive a signal from the wireless communication system (18), namely an emitter (40). The emitter (40) could be a hand-held activation at the POS, an antenna located somewhere in the store, or an antenna of a global network and operated through a third party. For instance, in the latter case, this network could use frequencies at 27 kHz, 58 kHz, 8.2 MHz, or 144-152 MHz. It could also be operating in the range of 925-950 MHz. The final frequency or range of frequencies and method chosen would depend upon the application, the commercial agreement to be established with a service provider, as well as the preferred characteristics of wave propagation. In the case of a global network, the retail store would be in communication with a central server (44), which server (44) receives an activation authorization and allows the activation signal to be broadcast in the case of global network. In all cases, the exchange of information with devices (12) is carried out in a secure manner using encryption and authentication methods to prevent any fraudulent use thereof.

The processor (20) accepts the output from the receiver (28), decodes it and analyses the data against a predetermined criteria to determine if a command signal should be generated. The format used by the decoder is, for instance, POCSAG (post office codes standardization advisory), ERMES (European radio message system), FLEX or any other. The sample bit rate used preferably varies between 2400 bps to 6400 bps. The processor (20) also incorporates checksum error checking routines to ensure integrity of the data being processed. The processor (20) is connected to an output terminal (30) through which enabling and disabling commands are issued. The output terminal (30) may be connected to one or more processors of the product itself, if any. These product processors would be designed to work only if the anti-theft device (12) allows it or them to do so. Therefore, unless proper authorization is obtained, someone in possession of product will be denied benefit of use because it will refuse to work.

In other instances, the device (12) may be provided with a switch (31) connected to the output terminal (30). The switch (30) is used as a switch to shut off one or more electric or electronic components of the product (10). Preferably, the product (10) should be completely useless unless it is enabled by the device (12). However, only some functions may be disabled by the device (12). This could also allow to sell a product (10) for which the client has paid for only some of the functions. This could also be the case if the client is trying the product and will need to later pay additional fees to have it fully operational. The exact nature of the switch (31) will depend on the application. The type of load can be either resistive or inductive. The switch (31) is preferable isolated from the processor through the use of optoelectronics to avoid false triggering and to be applicable to the widest range of products.

If the receiver (28) is used in conjunction with a global network, the client, if he or she is within the covered area of the network, may activate the product (10) upon payment and from there, the product (10) could be activated without having to bring it back to the store where it was purchased.

Another interesting feature of the device (12) is the ability to turn off from a distance a product if a client fails to comply with payments therefor. In this situation, a deactivation signal would be sent to the product. The target product receives the signal at the receiver (28) and upon determining that the deactivation command is concerning the product, the corresponding process (20) will issue a shut off command.

Furthermore, the device (12) could enable manufacturers the ability to force product registration in effort to eliminate fraudulent product warranty claims by insuring accurate and timely warranty registration. Accordingly, a client may be denied benefit of use of his purchase product unless registration is properly sent to the manufacturer, for example through a web site. This will also provide the manufacturer or retailer with the opportunity to offer extended warranty coverage as well. Forced product registration could also eliminate the gray market if activation of particular products is only possible within a given area. Of course, many other applications are possible.

Optionally, the device (12) is provided with a display (34), which could be only one or more lights indicating activation and/or deactivation of a product. It could also be a small screen to display various information. The information to be displayed could be instructions, the serial number, advertisements, electronic coupons, messages for the user, warnings, etc.

It is further possible to include an I/O socket (34) to gain access to the processor (20) for programming, inquiring or for other reasons. A fuse may be provided to seal the access to the process (20). Thus, by melting the fuse, the 1/O socket (34) will be no longer operational. The I/O socket (34) can also be replaced by buttons or a keyboard.

Further, another interesting feature is that the device (12) can be provided with additional information such as known serial numbers of pirated media material. The purpose of this is to prevent pirated material from template if the serial number of the media, for instance a CD, is identified as a pirated material in the devices data base. Proper operation would then be denied.

The invention is not limited to the described embodiment and encompasses any alternative embodiments within the limits defined by the appended claims.

What is claimed is:

1. An anti-theft device (12) for use in a product (10) having an electric or electronic component therein, the device (12) comprising:
first means for receiving a first activation signal from an electronic article surveillance system and transmitting a response signal upon receiving the first activation signal;
the device (12) being characterized in that it also comprises:
second means for selectively enabling and disabling normal operation of the product (10); and
third means for receiving a second activation signal, the third means being coupled to the second means so that normal operation of the product (10) is enabled upon receiving the second activation signal.

2. An anti-theft device (12) in accordance to claim 1, characterized in that the first means comprise a transponder (26).

3. An anti-theft device (12) in accordance to claim 1 or 2, characterized in that the second means comprise a processor (20) having an output terminal (30) through which the processor (20) enables and disables at least part the product (10).

4. An anti-theft device (12) in accordance to claim 3, characterized in that it further comprises a switch (31) coupled to the output terminal (30).

5. A method of protecting a product (10) having an electric or electronic component therein, the method comprising:
receiving a first activation signal from an electronic article surveillance system and transmitting a response signal upon receiving the first activation signal;
the method being characterized in that it also comprises:
providing a product (10) in an at least partially disabled state;
receiving at the product (10) a second activation signal from a wireless activation system (18);
validating the second activation signal; and
enabling normal operation of the product (10) upon determining that the second activation signal is valid.

6. A method in accordance with claim 5, characterized in that enabling normal operation of the product (10) comprises issuing an enabling command to a processor that is part of the product (10) itself.

7. A method in accordance with claim 5, characterized in that enabling normal operation of the product (10) comprises issuing an enabling command to a switch (31).

8. A method in accordance with any one of claims 5 to 7, characterized in that it further comprises:
determining that the product (10) needs to be disabled;
receiving at the product (10) a deactivation signal from a wireless activation system (18);
validating the deactivation signal; and
disabling normal operation of the product (10) upon determining that the deactivation signal is valid.

9. A method in accordance with any one of claims 5 to 8, characterized in that the response signal comprises data to identify the product (10).

10. A method in accordance with claim 9, characterized in that the data comprises a serial number.
